(19) United States
(12) Patent Application Publication
(10) Pub. No.: US 2021/0300271 A1
(43) Pub. Date: Sep. 30, 2021

(54) POWER SUPPLY CIRCUIT

(71) Applicant: DENSO CORPORATION, Kariya-city (JP)

(72) Inventor: Shun TOMIOKA, Kariya-city (JP)

(21) Appl. No.: 17/346,666

(22) Filed: Jun. 14, 2021

Related U.S. Application Data
(63) Continuation of application No. PCT/JP2019/049225, filed on Dec. 16, 2019.

(30) Foreign Application Priority Data
Dec. 17, 2018 (JP) 2018-235472

(51) Int. Cl. B60R 16/033; G06F 1/30; G06F 3/06; G06F 9/06; G06F 13/40

(52) U.S. Cl. CPC B60R 16/033; G06F 1/30; G06F 13/40; G06F 9/06; G06F 3/0601

(57) ABSTRACT

A power supply circuit is provided for a vehicle. The vehicle includes a battery, a calculation processing device, and a storage device. The storage device stores data used by the calculation processing device. The power supply circuit detects whether power supply to the power supply circuit is turned on based on output information from the battery.

### CROSS REFERENCE TO RELATED APPLICATIONS

The present application is a continuation application of International Patent Application No. PCT/JP2019/049225 filed on Dec. 16, 2019, which designated the U.S. and claims the benefit of priority from Japanese Patent Application No. 2018-235472 filed on Dec. 17, 2018. The entire disclosures of all of the above applications are incorporated herein by reference.

### TECHNICAL FIELD

The present disclosure relates to a power supply circuit for a vehicle.

### BACKGROUND

In recent years, the number of in-vehicle devices having a safety function in addition to a navigation function and an audio function has increased. Thus, the amount of program data stored in a storage device of in-vehicle device has dramatically increased. As the amount of data programs stored in the storage device increases, startup of in-vehicle devices tends to be delayed. However, in-vehicle devices are required to start up at high speed as in the case when the amount of program data was relatively small.

### SUMMARY

The present disclosure provides a power supply circuit for a vehicle. The vehicle includes a battery, a calculation processing device, and a storage device. The storage device stores data used by the calculation processing device. The power supply circuit detects whether power supply to the power supply circuit is turned on based on output information from the battery.

### BRIEF DESCRIPTION OF DRAWINGS

The features and advantages of the present disclosure will become more apparent from the following detailed description made with reference to the accompanying drawings. In the drawings:

FIG. 1 is a block diagram showing a configuration of a power supply system;

FIG. 2 is a block diagram showing a configuration of a power supply IC;

FIG. 3 is a sequence diagram showing a normal startup process;

FIG. 4 is a diagram showing a comparison of startup times of system between a present embodiment and a reference example;

FIG. 5 is a sequence diagram showing a normal termination process;

FIG. 6 is a sequence diagram showing an emergency termination process;

FIG. 7 is a diagram showing a comparison of emergency termination times of system between a present embodiment and a reference example; and

FIG. 8 is a block diagram showing a configuration of a power supply IC according to another embodiment.

### DETAILED DESCRIPTION

For example, an information process device includes a main CPU and a sub-microcomputer that takes less time to start the OS than the main CPU in order to realize high-speed startup. In the information process device, while the main CPU is executing its own initialization process and OS boot process, the sub-microcomputer executes its own initialization process and OS boot process and instructs the hard disk of initialization process. After the hard disk initialization process and the OS boot process of the sub-microcomputer are completed, the sub-microcomputer acquires data from the hard disk and stores the data in the memory. The main CPU accesses the memory and acquires data after the OS startup process of the main CPU is completed.

In an emergency where power supply to the storage device is unexpectedly interrupted due to a drop in voltage of the in-vehicle battery or the like, protection of the data in the storage device is required before voltage of the storage device drops to an inoperable voltage. However, in the information process device, mutual confirmation of the situation is always required between the main CPU and the sub-microcomputer. As a result of detailed examination by the inventor, it has been found that, even in an emergency, the information process device performs the protection process of the storage device after mutual confirmation between the main CPU and the sub-microcomputer. Thus, the protection cannot be made in time and the data may fail.

The present disclosure provides a power supply circuit that enables both high-speed startup of system and protection of storage data.

An exemplary embodiment of the present disclosure provides a power supply circuit for a vehicle. The vehicle includes a battery, a calculation processing device, and a storage device. The storage device is configured to store data used by the calculation processing device. The power supply circuit includes a power input unit, a connection unit, a setting unit, and a storage control unit. The power input unit is configured to detect whether power supply to the power supply circuit is turned on based on output information from the battery. The connection unit is configured to connect a communication path between the storage device and one of the power supply circuit and the calculation processing device as a connection destination. The setting unit is configured to set the power supply circuit as the connection destination when the power input unit detects that the power supply to the power supply circuit is turned on. The storage control unit is configured to transmit an initialization command to the storage device after the connection unit connects the communication path between the storage device and the power supply circuit set as the connection destination in response to the power input unit detecting that the power supply to the power supply circuit is turned on.

In the exemplary embodiment of the present disclosure, the connection unit enables the power supply circuit and the storage device to be connected to communicate with each other without communicating with the calculation processing device. When it is detected that the power source to the power supply circuit is turned on, the storage device is connected to the power supply circuit to communicate with each other and the storage control unit of the power supply circuit transmits the initialization command to the storage device. Thus, the initialization of the storage device can be completed at an early stage. On the other hand, when the calculation processing unit is communicably connected to the power supply circuit and the storage device is communicably connected to the calculation processing unit, the initialization processing of the calculation processing device is first performed after it is detected that the power source is turned on. Then, the calculation processing device that has completed initialization transmits the initialization command to the storage device. Thus, the initialization completion of the storage device is delayed. In addition, since the storage device is connected to the power supply circuit to communicate with each other without communicating with the calculation processing unit, the storage device does not need to communicate with the calculation processing unit in an emergency. Thus, the storage device can perform protection processing at an early stage. Therefore, it is possible to achieve both high-speed startup of system and protection of storage data.

Hereinafter, embodiments for implementing the present disclosure will be described with reference to the drawings.

### 1. System Configuration

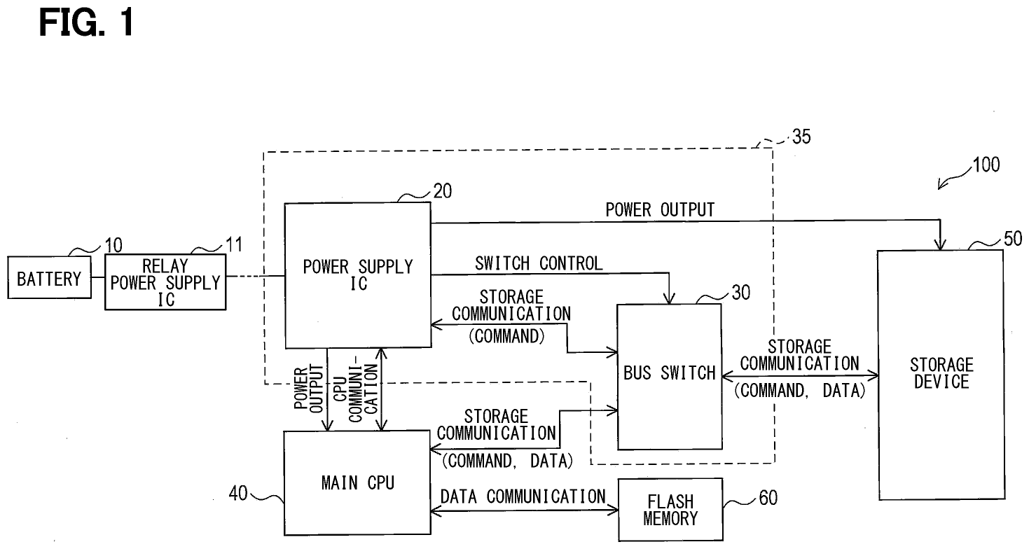

The following will describe a power supply system 100 of a vehicle according to the present embodiment with reference to FIG. 1.

The power supply system 100 includes a power supply circuit 35, a main CPU 40, a storage device 50, and a flash memory 60. The power supply circuit 35 is connected to a relay power supply IC 11. The relay power supply IC 11 is connected to a battery 10.

The battery 10 is a secondary battery mounted on a vehicle, for example, a lead battery or a lithium ion battery.

The relay power supply IC 11 generates an output power supply having a voltage lower than the power supply voltage from the power supply input from the battery 10 and outputs the output power supply to a power supply IC 20. The battery 10 may be connected to a plurality of relay power supply ICs 11. In this case, the voltage of the power supply output from the battery 10 is sequentially lowered via the plurality of relay power supply ICs 11, and finally the power supply is supplied to the power supply IC 20 included in the power supply circuit 35.

The main CPU 40 is mounted on an electronic control device (that is, an ECU) of a vehicle, and executes various processes according to the type of the ECU.

The storage device 50 stores data (for example, a program) used by the main CPU 40. The storage device 50 is communicably connected to one of the main CPU 40 and the power supply IC 20 via a bus switch 30 described later. The main CPU 40 accesses the storage device 50, reads data, and executes various processes using the read data.

The flash memory 60 stores the boot data of the main CPU 40 and is directly connected to the main CPU 40 so as to communicate with each other. When activated, the main CPU 40 reads the boot data from the flash memory 60 and executes an initialization process.

The power supply circuit 35 includes a power supply IC 20 and a bus switch 30.

The power supply IC 20 is connected to each of the main CPU 40 and the storage device 50 by a power supply line. Further, the power supply IC 20 is directly connected to the main CPU 40 so as to communicate with each other.

The bus switch 30 connects a communication path between one of the power supply IC 20 and the main CPU 40 set as a connection destination and the storage device 50. Specifically, the communication path between the bus switch 30 and the storage device 50 is always connected. On the other hand, the communication path between the bus switch 30 and the main CPU 40 and the communication path between the bus switch 30 and the power supply IC 20 can be connected and disconnected. That is, in the present embodiment, the storage device 50 is capable of communicating with the power supply IC 20 without communicating with the main CPU 40. In other words, the storage device 50 is capable of receiving a command directly from the power supply IC 20. In the present embodiment, the bus switch 30 corresponds to a connection unit of the present disclosure.

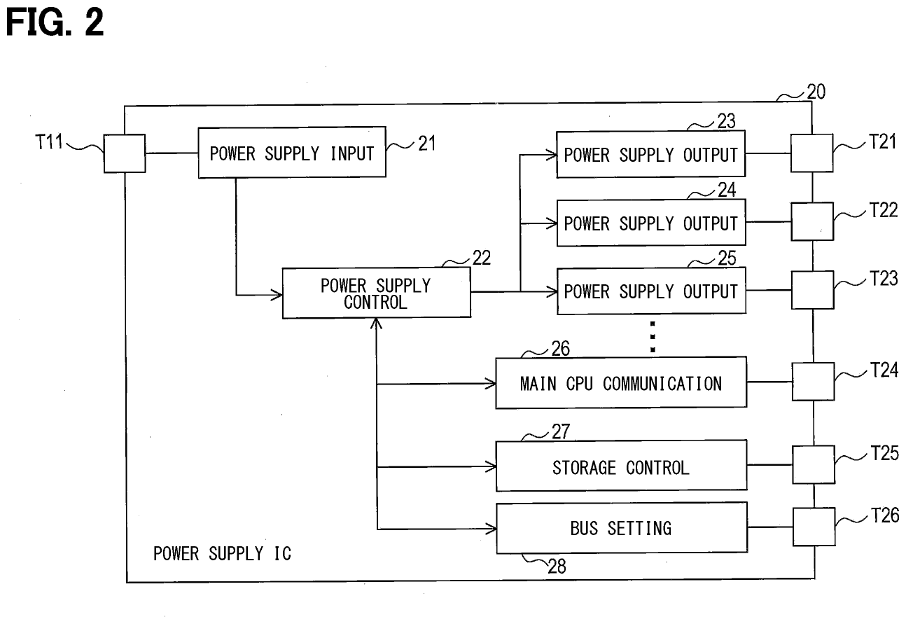

As shown in FIG. 2, the power supply IC 20 includes a power supply input unit 21, a power supply control unit 22, power supply output units 23 to 25, a main CPU communication unit 26, a storage control unit 27, and a bus setting unit 28. Further, the power supply IC 20 includes a power supply input terminal T11, power supply output terminals T21 to T23, a CPU communication terminal T24, a storage communication terminal T25, and a bus control terminal T26.

The power supply input unit 21 monitors the power supply output from the battery 10 based on the potential of the power supply input terminal T11. Specifically, the power supply input unit 21 detects that the power supply from the battery 10 to the power supply IC 20 is turned on based on a power supply on signal input to the power supply input terminal T11, and outputs, to the power supply control unit 22, an input signal indicating the power supply is input. The power supply input unit 21 detects that the power supply from the battery 10 to the power supply IC 20 is stopped based on a power supply off signal input to the power supply input terminal T11, and outputs, to the power supply control unit 22, a stop signal indicating that the power supply is stopped. The power supply on signal is a signal having a potential indicating that the power supply is turned on, and the power supply off signal is a signal having a potential indicating that the power supply is turned off. The power supply on signal and the power supply off signal are output from the battery 10 and input to the power supply input terminal T11 of the power supply IC 20 via the relay power supply IC 11.

Further, the power supply input unit 21 detects that the power supply from the battery 10 to the power supply IC 20 is interrupted based on the power supply voltage applied to the power supply input terminal T11, and outputs, to the power supply control unit 22, an interruption signal indicating that the power supply is interrupted. Specifically, the power supply input unit 21 detects that the power supply is interrupted when the input voltage becomes equal to or less than a threshold voltage. The threshold voltage is a value higher than the voltage at which the main CPU 40 and the storage device 50 become inoperable, and is a value lower than the voltage at the normal time. The power supply on signal and the power supply voltage input to the power supply input terminal T11 correspond to output information from the battery 10 of the present disclosure.

The power supply control unit 22 acquires various information via the power supply input unit 21, the main CPU communication unit 26, and the storage control unit 27, and based on the acquired information, controls the main CPU communication unit 26, the storage control unit 27, the bus setting unit 28, and the power supply output units 23 to 25. In the present embodiment, the power supply control unit 22 corresponds to an initialization power supply control unit and a termination power supply control unit of the present disclosure.

The power supply output unit 23 generates an output power supply suitable for the main CPU 40, and outputs the generated output power supply to the main CPU 40 via the power supply output terminal T21. The power supply output unit 24 generates an output power supply suitable for the storage device 50, and outputs the generated output power supply to the storage device 50 via the power supply output terminal T22. The power supply output unit 25 generates an output power supply suitable for another circuit of the ECU or the like, and outputs the generated output power supply via the power supply output terminal T23. The power supply IC 20 may include a plurality of power supply output units 25.

The main CPU communication unit 26 communicates with the main CPU 40 via the CPU communication terminal T24. The main CPU communication unit 26 outputs the notification received from the main CPU 40 to the power supply control unit 22. Further, the main CPU communication unit 26 outputs a notification to the main CPU 40. In the present embodiment, the main CPU communication unit 26 corresponds to a communication unit of the present disclosure.

The storage control unit 27 communicates with the storage device 50 via the storage communication terminal T25. The storage control unit 27 outputs the notification received from the storage device 50 to the power supply control unit 22. Further, the storage control unit 27 outputs a command to the storage device 50.

The bus setting unit 28 sets the connection destination of the bus switch 30 to one of the power supply IC 20 and the main CPU 40 via the bus control terminal T26. The bus setting unit 28 sets the power supply IC 20 as the connection destination when the power supply input unit 21 detects that the power supply is turned on. The bus setting unit 28 sets the power supply IC 20 as the connection destination when the power supply input unit 21 detects that the power supply is interrupted. Further, the bus setting unit 28 sets the main CPU 40 as the connection destination when the power supply control unit 22 confirms that the initialization processing of the main CPU 40 and the storage device 50 is completed. In the present embodiment, the bus setting unit 28 corresponds to a setting unit of the present disclosure.

### 2. Process

### 2-1. Startup Process

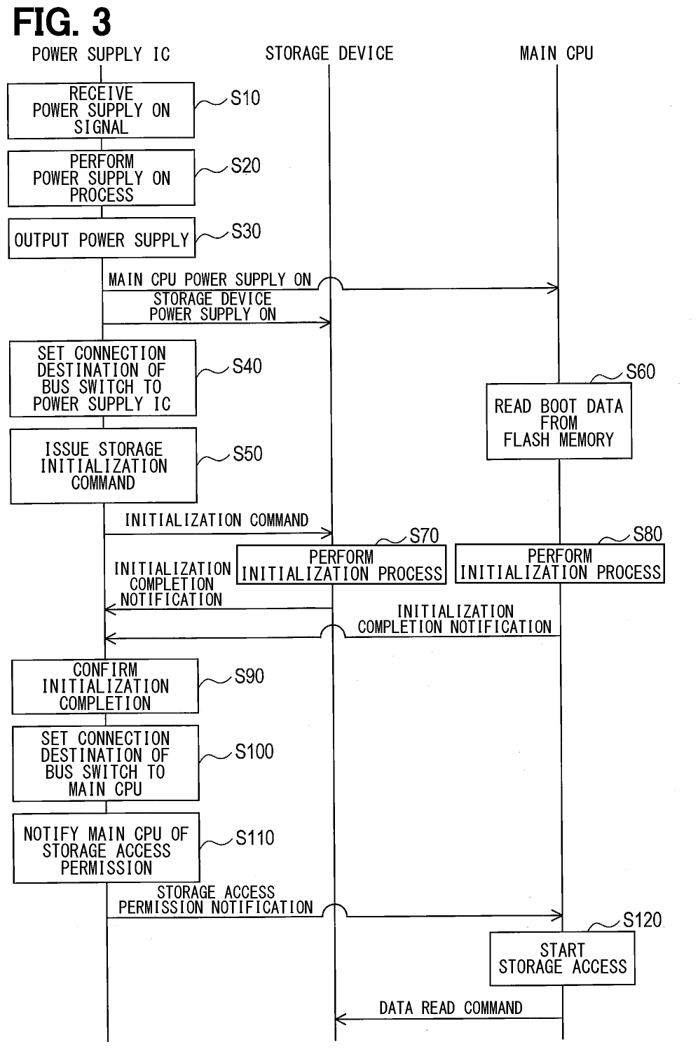

The startup process of the power supply system 100 is described next with reference to FIG. 3.

First, in S10, the power supply input unit 21 detects that the input of the power supply starts by receiving the power supply on signal via the power supply input terminal T11, and outputs the input signal indicating the power supply is turned on to the power supply control unit 22.

Subsequently, in S20, the power supply control unit 22 receives the input signal and executes the power supply on process. Specifically, the power supply control unit 22 outputs the input signal to the power supply output units 23 to 25, the bus setting unit 28, and the storage control unit 27.

Subsequently, in S30, the power supply output units 23 to 25 receive the input signal and start the output of the output power supply. The power supply output unit 23 generates an output power supply to be supplied from the input power supply to the main CPU 40, and outputs the power supply to the main CPU 40. Further, the power supply output unit 24 generates an output power supply to be supplied from the input power supply to the storage device 50, and outputs the output power supply to the storage device 50. The power supply output unit 25 generates an output power supply suitable for another circuit of the ECU or the like from the input power supply, and outputs the output power supply to the other circuit and the like.

Subsequently, in S40, the bus setting unit 28 receives the input signal and sets the connection destination of the bus switch 30. Specifically, the bus setting unit 28 sets the power supply IC 20 to the connection destination of the bus switch 30 via the bus control terminal T26 after the output of the output power supply to the main CPU 40 and the storage device 50 starts. As a result, the communication path is connected between the power supply IC 20 and the storage device 50 via the bus switch 30, and the storage control unit 27 is capable of communicating with the storage device 50.

Subsequently, in S50, the storage control unit 27 transmits an initialization command from the storage communication terminal T25 to the storage device 50 after the input signal is received and the communication path between the power supply IC 20 and the storage device 50 is connected.

Further, in S60, the main CPU 40 reads the boot data from the flash memory 60 while the power supply IC 20 executes the processes of S40 and S50.

In S70, the storage device 50 receives the initialization command from the power supply IC 20 and starts the initialization process. When the initialization process is completed, the storage device 50 transmits an initialization completion notification to the power supply IC 20. Further, when the storage device 50 detects an error during the initialization process, the storage device 50 transmits an error notification to the power supply IC 20.

In S80, the main CPU 40 starts the initialization process using the read boot data while the storage device 50 starts the initialization process. When the main CPU 40 starts receiving the output power supply, the main CPU 40 voluntarily reads the boot data and starts the initialization process. When the initialization process is completed, the main CPU 40 transmits an initialization completion notification to the power supply IC 20.

Subsequently, in S90, the power supply control unit 22 receives the initialization completion notification via the storage control unit 27, and confirms the initialization completion of the storage device 50. Further, the power supply control unit 22 receives the initialization completion notification via the main CPU communication unit 26, and confirms the initialization completion of the main CPU 40. When the power supply control unit 22 confirms the completion of initialization of the storage device 50 and the main CPU 40, the power supply control unit 22 outputs an initialization completion signal indicating the completion of initialization to the bus setting unit 28 and the main CPU communication unit 26.

When the power supply control unit 22 receives the error notification via the storage control unit 27, the power supply control unit 22 determines that a failure has occurred in the storage device 50 and outputs a power off command to the power supply output units 23 to 25. As a result, the power supply to the main CPU 40, the storage device 50, other circuits, and the like is stopped.

Subsequently, in S100, the bus setting unit 28 receives the initialization completion signal and sets the main CPU 40 as the connection destination of the bus switch 30 via the bus control terminal T26. As a result, the communication path is connected between the main CPU 40 and the storage device 50 via the bus switch 30, and the main CPU 40 is communicating with the storage device 50. As described above, the communication between the power supply IC 20 and the storage device 50 is limited by the completion of the initialization process, and after the initialization is completed, communication between the main CPU 40 and the storage device 50 is enabled. As a result, deterioration of access performance from the main CPU 40 to the storage device 50 is avoided.

Subsequently, in S110, the main CPU communication unit 26 transmits a storage access permission notification to the main CPU 40 via the CPU communication terminal T24 after the main CPU communication unit 26 receives the initialization completion signal and the communication path between the main CPU 40 and the storage device 50 is connected. This access permission notification includes status information of the storage device 50.

Subsequently, in S120, the main CPU 40 receives the storage access permission notification and reads the status information of the storage device 50. When the main CPU 40 determines that the storage device 50 is normal, the main CPU 40 starts access to the storage device 50 and transmits a data read command to the storage device 50. The main CPU 40 reads the data to be used from the storage device 50 and executes the OS or the application. This completes the startup process of the power supply system 100.

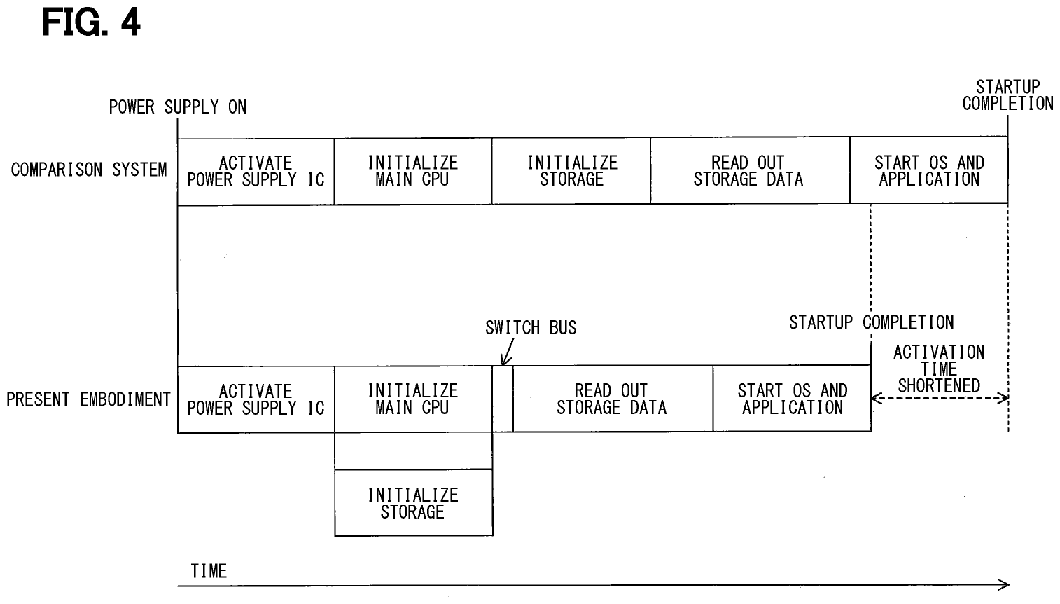

FIG. 4 shows a comparison of the startup times of the power supply system 100 of the present embodiment and a power supply system of a comparison example. In the power supply system of the comparison example, the bus switch 30 is not provided, and the connection destination of the storage device 50 is fixed to the main CPU 40. Therefore, when turning on of the power supply IC 20 is detected, the main CPU 40 first starts the initialization process. When the initialization of the main CPU 40 is completed, the initialization command is transmitted from the main CPU 40 to the storage device 50, and the storage device 50 starts the initialization process.

On the other hand, in the power supply system 100 of the present embodiment, since the bus switch 30 is provided, the connection destination of the storage device 50 can be switched between the power supply IC 20 and the main CPU 40. The connection destination of the storage device 50 is set to the power supply IC 20 until the initialization of the main CPU 40 and the storage device 50 is completed. As a result, the power supply IC 20 is responsible for instructing the storage device 50 to be initialized in addition to the power supply control in the power supply system 100. As a result, in the power supply system 100 of the present embodiment, the initialization process of the main CPU 40 and the initialization process of the storage device 50 are executed at the same time. Thus, the time until the startup is completed is shortened as compared with the comparison example.

### 2-2. Normal Termination Process

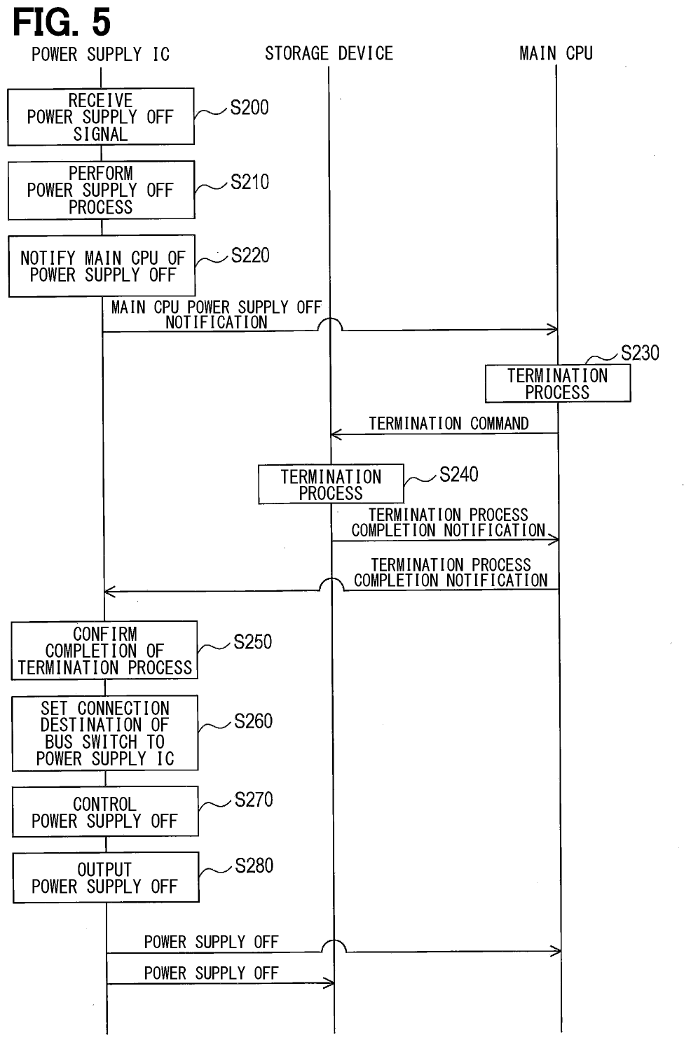

A normal termination process of the power supply system 100 is described next with reference to FIG. 5. The normal termination process is performed when the ignition is turned off.

First, in S200, the power supply input unit 21 detects that the power supply is turned off by receiving the power supply off signal via the power supply input terminal T11, and outputs the stop signal indicating the power supply to the power supply control unit 22 is stopped.

Subsequently, in S210, the power supply control unit 22 receives the stop signal and executes the power supply off process. Specifically, the power supply control unit 22 outputs the stop signal to the main CPU communication unit 26.

In S220, the main CPU communication unit 26 receives the stop signal, and transmits the power supply off notification to the main CPU 40 via the CPU communication terminal T24.

Subsequently, in S230, the main CPU 40 receives the power supply off notification and executes the termination process. The termination process stores the internal data of the main CPU 40 in the storage device 50 in order to keep the present state of the main CPU 40 before the storage device 50 is turned off and cause the main CPU 40 to start correctly at the next startup. Specifically, the main CPU 40 transmits a termination command to the storage device 50. At this time, the connection destination of the storage device 50 remains the main CPU 40 after the initialization process is completed.

Subsequently, in S240, the storage device 50 receives the termination command from the main CPU 40 and executes the termination process. Specifically, the storage device 50 stores the internal data of the main CPU 40. When the storage of the internal data of the main CPU 40 is completed, the storage device 50 transmits a termination process completion notification to the main CPU 40.

When the main CPU 40 receives the termination process completion notification from the storage device 50, the main CPU 40 transmits the termination process completion notification to the power supply IC 20. That is, in the normal termination process, the termination process completion notification is transmitted from the storage device 50 to the power supply IC 20 via the main CPU 40.

Subsequently, in S250, the power supply control unit 22 receives the termination process completion notification via the main CPU communication unit 26, and confirms the termination process completion. When the power supply control unit 22 confirms the completion of the termination process, the power supply control unit 22 outputs, to the bus setting unit 28, a termination completion signal indicating completion of the termination process.

Subsequently, in S260, the bus setting unit 28 receives the termination completion signal and sets the power supply IC 20 as the connection destination of the bus switch 30 via the bus control terminal T26. As a result, the communication path is connected between the power supply IC 20 and the storage device 50 via the bus switch 30.

Subsequently, in S270, the power supply control unit 22 turns off the power supply. That is, the power supply control unit 22 outputs a power off command to the power supply output units 23 to 25.

Subsequently, in S280, the power supply output units 23 to 25 receive the power off command and stop supplying the output power supply to the main CPU 40, the storage device 50, other circuits, and the like. This completes the normal completion process of the power supply system 100.

### 2-3. Emergency Termination Process

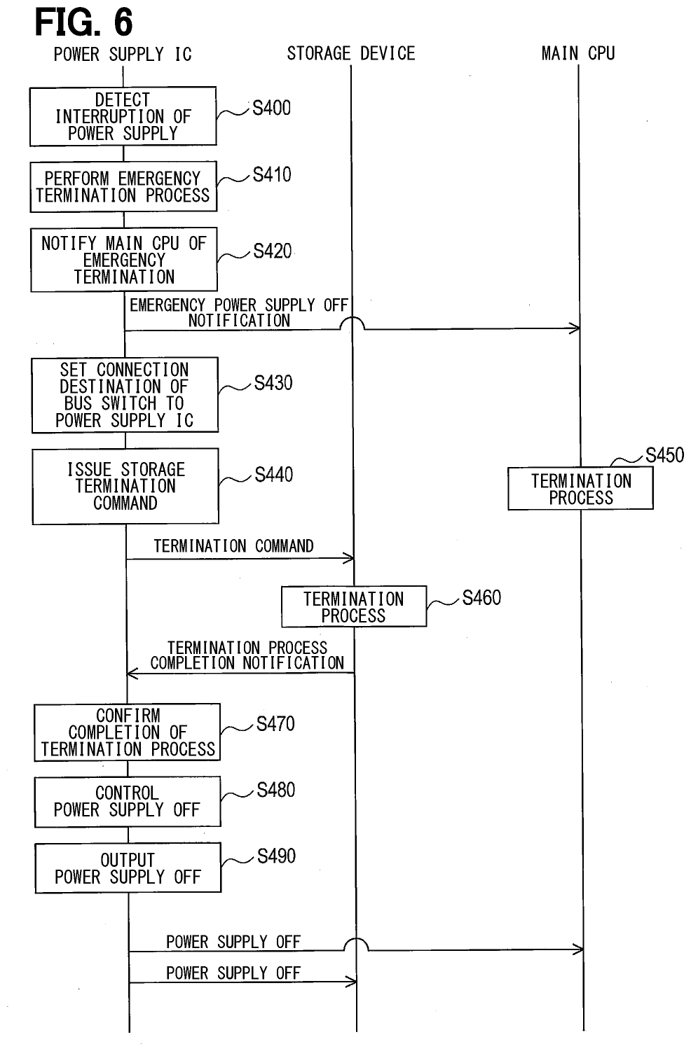

An emergency termination process of the power supply system 100 is described next with reference to FIG. 6. The emergency termination process is performed when the voltage of the battery 10 drops during the ignition on and the output power cannot be supplied to the main CPU 40 and the storage device 50. That is, the emergency termination process is executed to protect the data of the storage device 50 before the voltage of the power supplied to the power supply IC 20 drops to a voltage at which the main CPU 40 and the storage device 50 cannot operate.

First, in S400, when the input voltage input from the power supply input terminal T11 becomes lower than a voltage threshold value, the power input unit 21 detects that the power source is interrupted and outputs an interruption signal indicating the power interruption to the power supply control unit 22.

Subsequently, in S410, the power supply control unit 22 receives the interruption signal and executes the emergency termination process. Specifically, the power supply control unit 22 outputs the interruption signal to the main CPU communication unit 26, the bus setting unit 28, and the storage control unit 27.

In S420, the main CPU communication unit 26 receives the interruption signal, and transmits the emergency power supply off notification to the main CPU 40 via the CPU communication terminal T24.

Subsequently, in S430, the bus setting unit 28 receives the interruption signal and sets the power supply IC 20 as the connection destination of the bus switch 30 via the bus control terminal T26. As a result, the communication path is connected between the power supply IC 20 and the storage device 50 via the bus switch 30.

Subsequently, in S440, the storage control unit 27 receives the interruption signal and transmits a termination command to the storage device 50 via the storage communication terminal T25.

In S450, the power supply IC 20 executes the processes of S430 and S440, while the main CPU 40 receives the emergency power off notification and starts the termination process. Specifically, the main CPU 40 stops access to peripheral devices including the storage device 50 so as not to fail the peripheral devices including the storage device 50.

Further, in S460, the storage device 50 receives the termination command and executes the termination process. Specifically, the storage device 50 stores the internal data of the main CPU 40. When the storage of the internal data of the main CPU 40 is completed, the storage device 50 transmits a termination process completion notification to the power source IC 20. That is, in the emergency process, the termination process completion notification is directly transmitted from the storage device 50 to the power supply IC 20 without communicating with the main CPU 40.

Subsequently, in S470, the power supply control unit 22 receives the termination process completion notification via the storage control unit 27 and confirms the completion of the termination process.

Subsequently, in S480, the power supply control unit 22 executes the similar process to the process in S270.

Subsequently, in S490, each of the power supply output units 23 to 25 executes the similar process to the process in S280. This completes the emergency completion process of the power supply system 100.

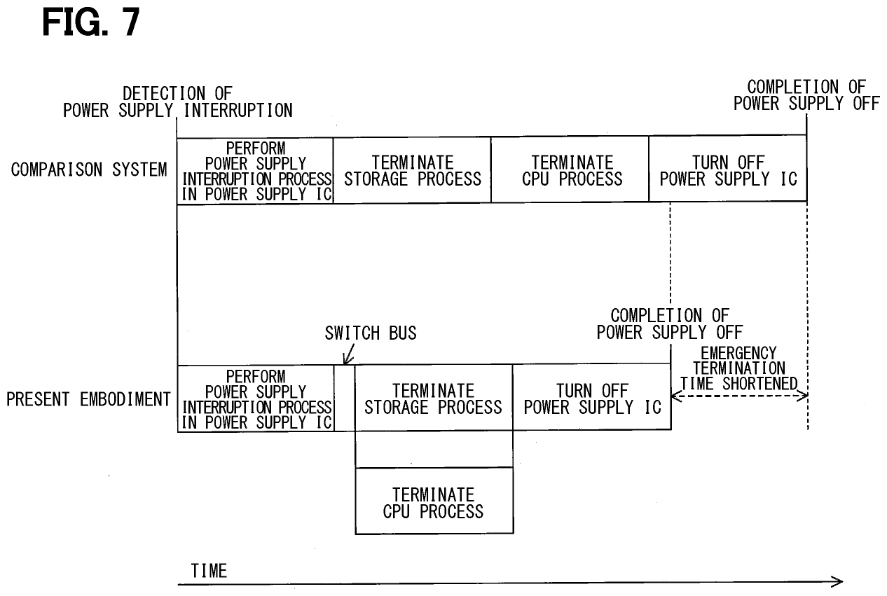

FIG. 7 shows a comparison of the emergency termination times of the power supply system 100 of the present embodiment and a power supply system of a comparison example. In the power supply system of the comparison example, the same processing as at the time of normal termination is executed even at the time of emergency termination. That is, the termination command is transmitted from the main CPU 40 to the storage device 50, and the termination process completion notification is transmitted from the storage device 50 to the main CPU 40. The main CPU 40 confirms the completion of the termination process and transmits the termination process completion notification to the power supply IC 20.

On the other hand, in the power supply system 100 of the present embodiment, the bus switch 30 is provided. Thus, the connection destination of the storage device 50 is set to the power supply IC 20 at the time of emergency termination, and the termination command is transmitted from the power supply IC 20 to the storage device 50. Further, the termination completion notification can be directly transmitted from the storage device 50 to the power supply IC 20. Therefore, the time required to complete the emergency termination process is shortened as compared with the power supply system of the comparison example. As a result, the emergency termination process can be completed before the power supply voltage supplied from the battery 10 drops to a voltage at which the storage device 50 becomes inoperable.

### 3. Effect

According to the first embodiment described above, the following effects can be exhibited.

(1) Since the power supply circuit 35 includes the bus switch 30, the storage device 50 can be communicably connected to the power supply IC 20 without communicating with the main CPU 40. Therefore, when it is detected that the power source to the power source IC 20 is turned on, the storage device 50 is connected to the power supply IC 20, and the storage control unit 27 transmits the initialization command to the storage device 50. Therefore, the initialization of the storage device 50 can be completed earlier than the case where the initialization command is transmitted from the main CPU 40 to the storage device 50. As a result, the startup speed of the power supply system 100 can be improved.

(2) When it is detected that the power source to the power supply IC 20 is interrupted, the storage device 50 is communicably connected to the power supply IC 20 without communicating with the main CPU 40, and the storage control unit 27 transmits the termination command to the storage device 50. Therefore, the termination of the storage device 50 can be completed earlier than the case where the termination command is transmitted from the main CPU 40 to the storage device 50. As a result, the data of the storage device 50 can be appropriately protected at the time of emergency termination.

(3) When it is confirmed that the initialization process of the storage device 50 and the main CPU 40 is completed, the storage device 50 is connected to the main CPU 40 to communicate with each other. As a result, after the startup of the power supply system 100 is completed, the deterioration of the access performance from the main CPU 40 to the storage device 50 is avoided, and the main CPU 40 can execute various processes using the data stored in the storage device 50.

(4) The power supply control unit 22 can directly receive the termination process completion notification from the storage device 50 and confirm the completion of the termination process of the storage device 50.

(5) When the main CPU 40 receives the supply of the output power supply, the main CPU 40 voluntarily starts the initialization process. On the other hand, the storage device 50 receives the initialization command from the power supply IC 20 and starts the initialization process. Therefore, after the output of the output power supply to the main CPU 40 and the storage device 50 is started, the initialization process of the main CPU 40 and the storage device 50 is executed at the same time by setting the connection destination of the bus switch 30 to the power supply IC 20.

(6) After the completion of the termination process of the storage device 50 is confirmed, the output of the output power supply to the storage device 50 is stopped. As a result, the data stored in the storage device 50 can be appropriately protected.

(7) After the completion of the initialization process is confirmed and the storage device 50 is connected to the main CPU 40 to communicate with each other, the main CPU 40 is notified of the access permission to the storage device 50. As a result, the main CPU 40 can recognize that the initialization process of the storage device 50 is completed and the storage device 50 can be used.

### OTHER EMBODIMENTS

Although embodiments of the present disclosure have been described above, the present disclosure is not limited to the above-described embodiments but various modifications can be made.

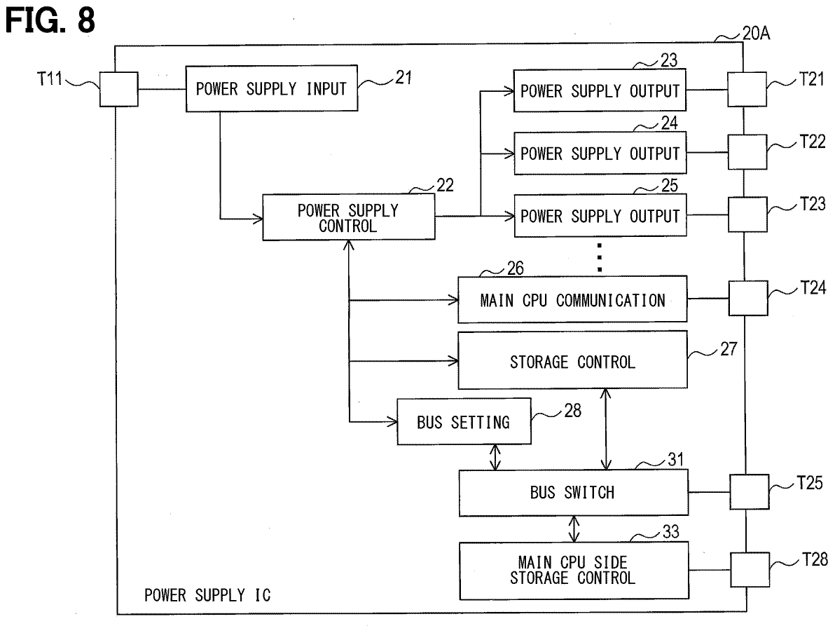

(a) In the above embodiment, the power supply circuit 35 separately includes the power supply IC 20 and the bus switch 30, but the power supply IC 20 and the bus switch 30 may not be separately provided. As shown in FIG. 8, the power supply circuit 35 may include a power supply IC 20A having a built-in bus switch unit 31 instead of the power supply IC 20 and the bus switch 30. In this case, the power supply IC 20A includes a bus switch unit 31, a main CPU side storage control unit 33, and a main CPU side storage communication terminal T28, in addition to the configuration of the power supply IC 20 other than the bus control terminal T26. The bus switch unit 31 is connected to the storage communication terminal T25. The main CPU side storage control unit 33 is connected to the main CPU side storage communication terminal T28. Further, the storage communication terminal T25 is always connected to the storage device 50 so as to be able to communicate. The storage communication terminal T28 on the main CPU side is always connected to the main CPU 40 so as to communicate with each other.

The bus switch unit 31 is connected to the storage control unit 27 when the power supply IC 20 is set as the connection destination by the bus setting unit 28. As a result, the storage control unit 27 is communicably connected to the storage device 50 via the bus switch unit 31 and the storage communication terminal T25.

On the other hand, the bus switch unit 31 is connected to the main CPU side storage control unit 33 when the main CPU 40 is set as the connection destination by the bus setting unit 28. As a result, the main CPU 40 is communicably connected to the storage device 50 via the main CPU side storage communication terminal T28, the main CPU side storage control unit 33, the bus switch unit 31, and the storage communication terminal T25.

(b) In the startup process of the power supply system 100, it is not necessary to execute the process of S110. Generally, the initialization process of the main CPU 40 takes more time than the initialization process of the storage device 50. Therefore, normally, when the main CPU 40 finishes the initialization process, the storage device 50 finishes the initialization process and the main CPU 40 is set as the connection destination of the bus switch 30. Even when the main CPU 40 may start accessing the storage device 50 without receiving the access permission notification when the initialization process is completed, or when a predetermined time has elapsed after the initialization process is completed.

(c) In the emergency termination process of the power supply system 100, the storage device 50 does not have to transmit the termination completion notification to the power supply ICs 20 and 20A. In this case, the power supply control unit 22 may confirm the completion of the termination process of the storage device 50 when a predetermined time has elapsed since the termination command was transmitted to the storage device 50. The predetermined time is preset according to the performance of the main CPU 40 and the storage device 50 and the like.

(d) Instead of the power supply ICs 20 or 20A that supplies output power to the main CPU 40 and the storage device 50, the relay power supply IC 11 may be communicably connected to the main CPU 40 and the storage device 50. The relay power supply IC 11 may have the functions of the power input unit 21, the power supply control unit 22, the main CPU communication unit 26, the storage control unit 27, the bus setting unit 28, the bus switch unit 31, and the main CPU side storage control unit 33. That is, the power supply circuit 35 may include a relay power supply IC 11 and a bus switch 30 instead of the power supply IC 20 and the bus switch 30. Further, the power supply circuit 35 may include a relay power supply IC 11 having the functions of the bus switch unit 31 and the main CPU side storage control unit 33 instead of the power supply IC 20A.

(e) A plurality of functions of one element in the above embodiment may be implemented by a plurality of elements, or one function of one element may be implemented by a plurality of elements. In addition, multiple functions of multiple components may be realized by one component, or a single function realized by multiple components may be realized by one component. A part of the configuration of the above embodiment may be omitted. At least a part of the configuration of the above embodiments may be added to or replaced with the configuration of another one of the above embodiments.

(f) In addition to the power supply circuit described above, the present disclosure can be realized in various forms such as a power supply system having a power supply circuit as a component.

What is claimed is:

1. A power supply circuit for a vehicle, wherein
the vehicle includes:
a battery,
a calculation processing device, and
a storage device configured to store data used by the calculation processing device,
the power supply circuit comprising:
a power input unit configured to detect whether power supply to the power supply circuit is turned on based on output information from the battery;
a connection unit configured to connect a communication path between the storage device and one of the power supply circuit and the calculation processing device as a connection destination;
a setting unit configured to set the power supply circuit as the connection destination when the power input unit detects that the power supply to the power supply circuit is turned on; and
a storage control unit configured to transmit an initialization command to the storage device after the connection unit connects the communication path between the storage device and the power supply circuit set as the connection destination in response to the power input unit detecting that the power supply to the power supply circuit is turned on.

2. The power supply circuit according to claim 1, wherein
the power input unit detects whether the power supply to the power supply circuit is interrupted based on the output information from the battery,
the setting unit sets the power supply circuit as the connection destination when the power input unit detects that the power supply to the power supply circuit is interrupted, and
the storage control unit transmits a termination command to the storage device after the connection unit connects the communication path between the storage device and the power supply circuit set as the connection destination in response to the power input unit detecting that the power supply to the power supply circuit is interrupted.

3. The power supply circuit according to claim 1, further comprising
an initialization power supply control unit configured to determine whether initialization processing of the storage device and the calculation processing device is completed, wherein
the setting unit sets the calculation processing device as the connection destination when the initialization power supply control unit determines that the initialization processing of the storage device and the calculation processing device is completed.

4. The power supply circuit according to claim 2, further comprising
a termination power supply control unit configured to determine termination processing of the storage device is completed.

5. The power supply circuit according to claim 1, further comprising
a power supply output unit configured to (i) generate, from the power supply input to the power supply circuit, output power supply, and (ii) output the output power supply to the calculation processing device and the storage device, wherein
the setting unit sets the power supply circuit as the connection destination after the power supply output unit starts outputting the output power supply in response to the power supply input unit detecting that the power supply is turned on.

6. The power supply circuit according to claim 4, further comprising
a power supply output unit configured to (i) generate, from the power supply input to the power supply circuit, output power supply, and (ii) output the output power supply to the calculation processing device and the storage device, wherein
the power supply output unit stops outputting the output power supply to the storage device after the termination power supply control unit determines the termination processing is completed.

7. The power supply circuit according to claim 3, further comprising
a communication unit configured to notify the calculation processing device that access to the storage device is permitted after the connection unit connects the communication path between the storage device and the calculation processing device as the connection destination.

8. A power supply circuit for a vehicle, wherein
the vehicle includes:
a battery,
a calculation processing device, and
a storage device configured to store data used by the calculation processing device,
the power supply circuit comprising:
a processor configured to detect whether power supply to the power supply circuit is turned on based on output information from the battery; and
a switch configured to connect a communication path between the storage device and one of the power supply circuit and the calculation processing device as a connection destination, wherein
the processor sets the power supply circuit as the connection destination when the processor detects that the power supply to the power supply circuit is turned on;
the processor transmits an initialization command to the storage device after the switch connects the communication path between the storage device and the power supply circuit set as the connection destination in response to the processor detecting that the power supply to the power supply circuit is turned on.
